(19) United States
(12) Patent Application Publication
(10) Pub. No.: US 2006/0018560 A1
(43) Pub. Date: Jan. 26, 2006

(54) Exposure device and exposure method

(76) Inventors: Tomoya Kitagawa, Kanagawa (JP); Kaoru Ohno, Kanagawa (JP)

Correspondence Address: TAIYO CORPORATION, 401 HOLLAND LANE, #407, ALEXANDRIA, VA, 22314, US

(21) Appl. No.: 11/175,262

(22) Filed: Jul. 7, 2005

(30) Foreign Application Priority Data
Jul. 9, 2004 (JP) 2004-203118
Jan. 18, 2005 (JP) 2005-010237

(51) Int. Cl. G06K 9/40

(52) U.S. Cl. 382/255

(57) ABSTRACT

An exposure device includes a distance measurement section, which measures heights of positions of an exposure surface of a photosensitive material, a hole position identification section, which determines positions of holes in the exposure surface of the photosensitive material, a hole co-ordinate measurement section, which identifies hole positions at the photosensitive material, a displacement data generation section, and a focusing section, which performs focusing control for aligning a focusing position of a light beam from an exposure section with the exposure surface. When a displacement amount of at least a predetermined magnitude is detected by the distance measurement section, the displacement data generation section excludes a position which is judged to be a hole on the basis of results of determinations by the hole position identification section and the hole position identification section, and the displacement data generation section prepares displacement data for focusing control by the focusing section.

### CROSS-REFERENCE TO RELATED APPLICATION

This application claims priority under 35 USC 119 from Japanese Patent Application Nos. 2004-203118 and 2005-010237, the disclosure of which is incorporated by reference herein.

### BACKGROUND OF THE INVENTION

1. Field of the Invention

The present invention relates to an exposure device and an exposure method, and more particularly relates to an exposure device and exposure method which are capable of exposing an image with accurate focus, without “focal shift” occurring even if a workpiece features reference holes, land holes or the like.

2. Description of the Related Art

In recent years, as examples of image recording devices, various exposure devices have been proposed which perform image exposure with a light beam modulated in accordance with image data, utilizing a spatial light modulator (SLM) such as a digital micromirror device (DMD) or the like (see, for example Non-Patent References 1 and 2). A DMD has a structure in which, for example, a large number of very small micromirrors are provided on memory cells of an SRAM. Angles of reflective surfaces of the micromirrors are changed by electrostatic forces caused by charges accumulated at the memory cells. In practice, when imaging is to be performed, image data is written to the SRAM and, in this state, the micromirrors are set to predetermined angles and directions of reflection of light are set to desired directions.

A field of application of this exposure device is, for example, the fabrication of substrates of flat-panel displays such as liquid crystal displays, plasma displays and the like, or the fabrication of printed circuit boards.

As an exposure device for fabrication of panels or printed circuit boards or the like, there is a multi-head exposure device at which, with a view to widening an exposure range, exposure heads featuring DMDs are plurally arranged along a direction of conveyance of a substrate and along a direction intersecting the direction of conveyance.

At this multi-head exposure device, detection sections and an adjustment section are provided (see Japanese Patent No. 3,305,448). The detection sections measure displacements of the substrate at a plurality of measurement points. The adjustment section adjusts a positional relationship between an imaging plane of a projecting optical system, such as an exposure head, and the substrate on the basis of displacement data measured by the detection section. By maintaining focus using such means, correction is performed for exposure which responds to unevenness of the substrate surface, variations in thickness and the like.

Generally, reference holes are formed in the substrate as reference points for positioning the substrate at the multi-head exposure device. Further, holes, grooves and the like for mounting of various components at the workpiece, known as land holes, may be provided. In the present specification, the term “holes” includes such holes and indentation steps.

However, when a substrate in which these reference holes and the like are formed is exposed using the above-described multi-head exposure device, when displacements of the substrate in a Z direction (a substrate thickness direction) are measured with laser displacement meters provided at the detection sections, laser light irradiated from the laser displacement meters may pass through the reference holes and the like.

Furthermore, measurement ranges of the detection sections on the substrate are points which are set apart, with surroundings of the measurement points being focus-adjusted in accordance with the measurement results of the measurement points. In particular, in an X direction (the direction intersecting the direction of movement of the substrate), a spacing between measurement points is simply a spacing between detection sections. Consequently, spacings between respective measurement points are wider in the X direction.

In consequence, raw displacement measurement results measured by a detection section may include displacements of reference holes and the like. As a result, if displacement data is generated and focus adjustment performed using such displacement measurement results in the raw state, where a measurement point of the detection section is a hole, a recess portion or the like, a region peripheral thereto may be exposed with focusing which is matched to the measurement point. Moreover, in the conventional technology described above, there is a problem in that, depending on a degree of unevenness, it may be difficult to distinguish between machined holes, recess portions, etc. and warping of the substrate, and appropriate responses may not be possible.

### SUMMARY OF THE INVENTION

An exposure device and exposure method are demanded, which are capable of exposing a workpiece such as a substrate or the like with accurate focus, even if the workpiece is provided with holes, such as reference holes and the like, and/or indentation portions and the like.

In order to solve the problems described above, a first aspect of the invention relates to an exposure device for exposing a photosensitive material with an exposure section which emits a light beam modulated in accordance with image data while the photosensitive material is relatively moved, the exposure device including: a hole position identification section, which determines a position of a hole in an exposure surface of the photosensitive material; a focusing section, which performs focusing control for causing a focusing position of the light beam from the exposure section to coincide with the exposure surface; and a displacement data generation section, which generates displacement data for the focusing control by the focusing section, excluding a position which is determined, on the basis of results of determination by the hole position identification section, to be the hole.

The holes may be, as described earlier, reference holes (alignment marks) which are used for alignment of a workpiece, land holes for mounting various components at the workpiece, and so forth. All of these are considered as holes. Further, in addition to holes, protrusion portions (which may be alignment marks) may also be considered thus. That is, it is possible for the displacement data generation section to generate displacement data for regions excluding portions of unevenness.

The workpiece may be a single-layer or multi-layer printed circuit board including a photosensitive layer, a flat panel display substrate, a rigid-flexible substrate (a flexible circuit board), a sheet-form or strip-form printed wiring board (PWB), a display device substrate, a liquid crystal cell formation structure, a filter or the like (these are hereafter referred to as the photosensitive material). Further, types of a photosensitive layer include photoresists, materials which are cured by light, materials which can be developed by light, and so forth.

A second aspect of the present application relates to an exposure method for exposing a photosensitive material by emitting a light beam which is modulated in accordance with image data while the photosensitive material is being relatively moved, the method including: determining a position of a hole in an exposure surface of the photosensitive material; performing focusing control for causing a focusing position of the light beam to coincide with the exposure surface; and generating displacement data for the focusing control, excluding a position which is determined, on the basis of results of determination of the hole position, to be the hole.

A third aspect of the present application relates to an exposure device for exposing a workpiece with one or a plurality of an exposure head, which relatively moves with respect to the workpiece, the exposure device including: a workpiece displacement measurement section, which measures displacements of an exposure surface of the workpiece; a hole co-ordinate measurement section, which finds a co-ordinate of a hole formed in the workpiece; a displacement data generation section, which generates displacement data of the exposure surface in accordance with results of measurement at the workpiece displacement measurement section; and a focusing section, which aligns a focusing point of a light beam emitted from the exposure head with the exposure surface on the basis of the displacement data generated by the displacement data generation section, wherein, when a displacement amount equal to or greater than a predetermined magnitude is detected by the workpiece displacement measurement section, the displacement data generation section compares a position of detection of this displacement amount with a hole co-ordinate position found by the hole co-ordinate measurement section and, if the two positions coincide, determines that a step corresponding to the displacement amount corresponds to the hole formed in the workpiece and, for a predetermined range about the hole, sets a displacement amount which differs from the measured displacement amount for generating the displacement data.

A fourth aspect of the present application relates to an exposure device for exposing a workpiece with one or a plurality of an exposure head, which relatively moves with respect to the workpiece, the exposure device including: a workpiece displacement measurement section, which measures displacements of an exposure surface of the workpiece; a displacement data generation section, which generates displacement data of the exposure surface in accordance with results of measurement at the workpiece displacement measurement section; and a focusing section, which aligns a focusing point of a light beam emitted from the exposure head with the exposure surface on the basis of the displacement data generated by the displacement data generation section, wherein, when a displacement amount equal to or greater than a predetermined magnitude is detected by the workpiece displacement measurement section, the displacement data generation section compares a position of detection of this displacement amount with a hole co-ordinate position inputted by a user beforehand and, if the two positions coincide, determines that a step corresponding to the displacement amount corresponds to the hole formed in the workpiece and, for a predetermined range about the hole, sets a displacement amount which differs from the measured displacement amount for generating the displacement data.

A fifth aspect of the present application relates to an exposure device for exposing a workpiece with one or a plurality of an exposure head, which relatively moves with respect to the workpiece, the exposure device including: a workpiece displacement measurement section, which measures displacements of an exposure surface of the workpiece; a hole co-ordinate measurement section, which finds a co-ordinate of a hole formed in the workpiece; a displacement data generation section, which generates displacement data of the exposure surface in accordance with results of measurement at the workpiece displacement measurement section; and a focusing section, which aligns a focusing point of a light beam emitted from the exposure head with the exposure surface on the basis of the displacement data generated by the displacement data generation section, wherein, when a displacement amount equal to or greater than a predetermined magnitude is detected by the workpiece displacement measurement section, the displacement data generation section compares a position of detection of this displacement amount with a hole co-ordinate position found by the hole co-ordinate measurement section and a hole co-ordinate position inputted by a user beforehand, and, if the three positions coincide, determines that a step corresponding to the displacement amount corresponds to the hole formed in the workpiece and, for a predetermined range about the hole, sets a displacement amount which differs from the measured displacement amount for generating the displacement data.

A sixth aspect of the present application relates to an exposure method for exposing a workpiece with one or a plurality of an exposure head, which relatively moves with respect to the workpiece, the exposure method including: a workpiece displacement measurement step for measuring displacements of an exposure surface of the workpiece; a displacement data generation step for generating displacement data of the exposure surface in accordance with results of measurement in the workpiece displacement measurement step; a focusing step for aligning a focusing point of a light beam emitted from the exposure head with the exposure surface on the basis of the displacement data generated by the displacement data generation step; and a hole co-ordinate measurement step for finding a co-ordinate of a hole formed in the workpiece, wherein, when a displacement amount equal to or greater than a predetermined magnitude is detected in the workpiece displacement measurement step, the displacement data generation step includes comparing a position of detection of this displacement amount with a hole co-ordinate position found by the hole co-ordinate measurement step and, if the two positions coincide, judging that a step corresponding to the displacement amount corresponds to the hole formed in the workpiece and, for a predetermined range about the hole, setting a displacement amount which differs from the measured displacement amount for generating the displacement data.

A seventh aspect of the present application relates to an exposure method for exposing a workpiece with one or a plurality of an exposure head, which relatively moves with respect to the workpiece, the exposure method including: a workpiece displacement measurement step for measuring displacements of an exposure surface of the workpiece; a displacement data generation step for generating displacement data of the exposure surface in accordance with results of measurement in the workpiece displacement measurement step; and a focusing step for aligning a focusing point of a light beam emitted from the exposure head with the exposure surface on the basis of the displacement data generated by the displacement data generation step, wherein, when a displacement amount equal to or greater than a predetermined magnitude is detected in the workpiece displacement measurement step, the displacement data generation step includes comparing a position of detection of this displacement amount with a hole co-ordinate position inputted by a user beforehand and, if the two positions coincide, judging that a step corresponding to the displacement amount corresponds to the hole formed in the workpiece and, for a predetermined range about the hole, setting a displacement amount which differs from the measured displacement amount for generating the displacement data.

An eighth aspect of the present application relates to an exposure method for exposing a workpiece with one or a plurality of an exposure head, which relatively moves with respect to the workpiece, the exposure method including: a workpiece displacement measurement step for measuring displacement of an exposure surface of the workpiece; a hole co-ordinate measurement step for finding a co-ordinate of a hole formed in the workpiece; a displacement data generation step for generating displacement data of the exposure surface in accordance with results of measurement in the workpiece displacement measurement step; and a focusing step for aligning a focusing point of a light beam emitted from the exposure head with the exposure surface on the basis of the displacement data generated by the displacement data generation step, wherein, when a displacement amount equal to or greater than a predetermined magnitude is detected in the workpiece displacement measurement step, the displacement data generation step includes comparing a position of detection of this displacement amount by the workpiece displacement measurement step with a hole co-ordinate position found in the hole co-ordinate measurement step and a hole co-ordinate position inputted by a user beforehand, and, if the three positions coincide, first judging that a step corresponding to the displacement amount corresponds to the hole formed in the workpiece and, for a predetermined range about the hole, setting a displacement amount which differs from the measured displacement amount for generating the displacement data.

A ninth aspect of the present application relates to an exposure device for exposing a photosensitive material with an exposure section which emits a light beam modulated in accordance with image data while the photosensitive material is relatively moved, the exposure device including: an unevenness portion position identification section, which determines a position of an unevenness portion of an exposure surface of the photosensitive material; a focusing section, which performs focusing control for causing a focusing position of the light beam from the exposure section to coincide with the exposure surface; and a displacement data generation section, which generates displacement data for the focusing control by the focusing section, excluding a position which is determined, on the basis of results of determination by the unevenness portion position identification section, to be the unevenness portion.

A tenth aspect of the present application relates to an exposure method for exposing a photosensitive material by emitting a light beam which is modulated in accordance with image data while the photosensitive material is being relatively moved, the method including: determining a position of an unevenness portion of an exposure surface of the photosensitive material; performing focusing control for causing a focusing position of the light beam to coincide with the exposure surface; and generating displacement data for the focusing control, excluding a position which is determined, on the basis of results of determination of the unevenness portion position, to be the unevenness portion.

### BRIEF DESCRIPTION OF THE DRAWINGS

FIG. 1 is a schematic perspective view showing overall structure of an exposure device relating to an embodiment.

FIG. 2 is a schematic side view showing overall structure of the exposure device relating to the embodiment.

FIG. 3 is a perspective view showing structure of an exposure unit provided at the exposure device relating to the embodiment.

FIG. 4A is a plan view showing exposed regions which are formed on a photosensitive material.

FIG. 4B is a schematic view showing an arrangement of exposure areas due to respective exposure heads.

FIG. 5 is a perspective view showing general structure of an exposure head provided at the exposure device relating to the embodiment.

FIGS. 6A and 6B are sectional views, cut in a scanning direction along an optical axis, showing structure of the exposure head shown in FIG. 5.

FIG. 7 is a schematic plan view showing relative positional relationships of the exposure heads, displacement measurement units and alignment detection units.

FIG. 8 is a partial enlarged view showing structure of a digital micromirror device (DMD) provided at the exposure head shown in FIG. 5.

FIGS. 9A and 9B are explanatory views showing operation of the DMD shown in FIG. 8.

FIG. 10 is a perspective view showing the exterior of a focusing mechanism provided at an exposure head which is provided at the exposure device shown in FIG. 1.

FIGS. 11A and 11B are explanatory views showing operation of a focusing mechanism shown in FIG. 10.

FIG. 12 is a block diagram showing structure of a controller provided at the exposure device of FIG. 1.

FIG. 13 is a plan view showing an example of reference holes formed in a photosensitive material which is to be exposed by the exposure device of FIG. 1.

FIG. 14 is a graph showing an example of displacement data at a displacement measurement unit when it is determined that a hole is present.

FIG. 15 is a side view showing a relationship between a photosensitive material and laser displacement meters at a time of displacement measurement.

FIG. 16 is a block diagram showing a method of determining a hole position from a substrate machining process.

### DETAILED DESCRIPTION OF THE INVENTION

(1) Structure of Exposure Device

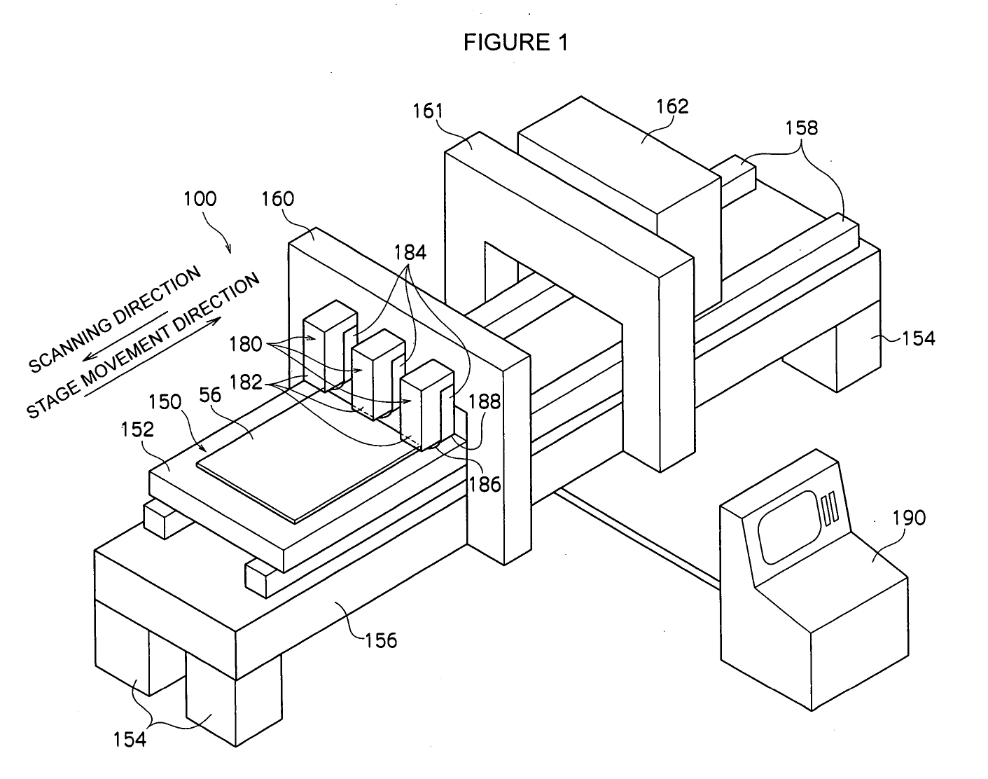

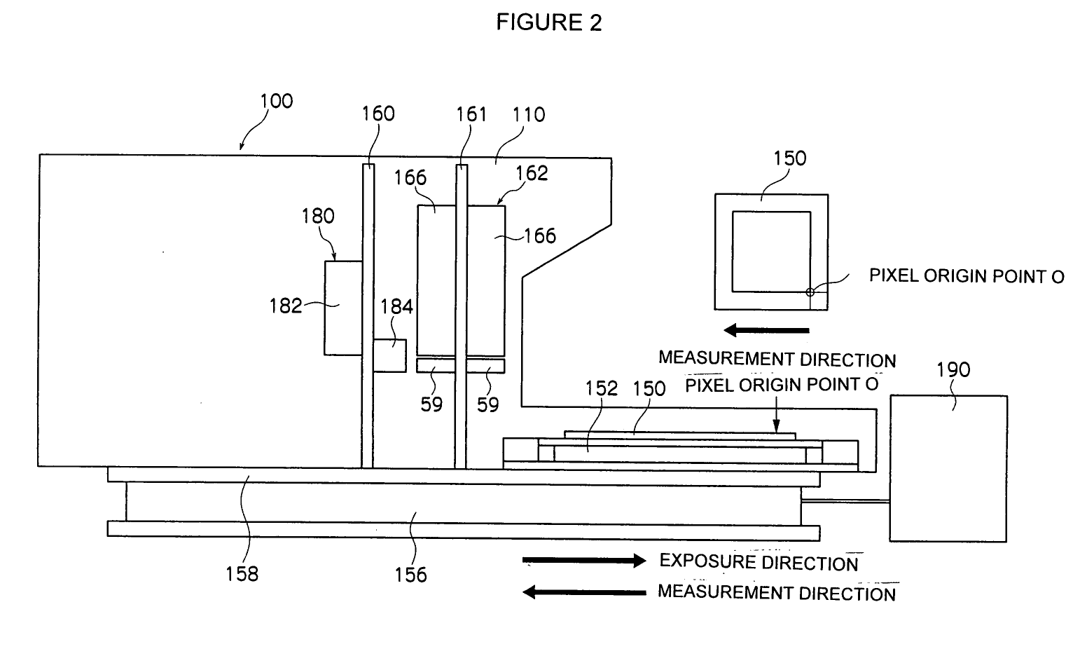

An exposure device 100 relating to a present embodiment is of a “flat-bed type”. As shown in FIGS. 1 and 2, the exposure device 100 is provided with a thick board-form equipment pedestal 156, which is supported at four leg portions 154, two guides 158 at an upper face of the equipment pedestal 156, which extend in a stage movement direction shown by an arrow in FIG. 1, and an exposure stage 152, which is supported by the guides 158 to be reciprocally movable. The exposure stage 152 is a pedestal on which a workpiece, such as a photosensitive material 150 or the like, is placed. The exposure stage 152 is disposed such that a length direction thereof is oriented in the stage movement direction. The exposure stage 152 can be moved along the guides 158 by a driving mechanism (not shown), and height of the exposure stage 152 can be adjusted.

The photosensitive material 150, as mentioned earlier, is an item at which a photosensitive layer is applied to a surface of a substrate or the like.

At a central portion of the equipment pedestal 156, an ‘n’-like gate 160 and gate 161 are provided so as to straddle a movement path of the exposure stage 152. Respective end portions of the gate 160 and the gate 161 are fixed at two side faces of the equipment pedestal 156. A detection unit 180 is provided at the gate 160. The detection unit 180 is formed with an alignment detection unit 182, which is provided at one side of the gate 160, and a displacement measurement unit 184, which is provided at the other side, sandwiching the gate 160. The alignment detection unit 182 and the displacement measurement unit 184 correspond to a hole co-ordinate measurement section and a distance measurement section, respectively, of the present invention. As the alignment detection unit 182, for example, CCD cameras are employed.

An exposure unit 162 is provided at the gate 161. The exposure unit 162 is equipped with, for example, eight exposure heads 166, which will be described later.

The exposure unit 162 and the detection unit 180 are connected to a controller 190. The controller 190 corresponds to a displacement data generation section of the present invention. The controller 190 prepares displacement data in accordance with displacements of an exposure surface of the photosensitive material, which are measured by the displacement measurement unit 184, and position co-ordinates of reference holes, which are found by photography by the alignment detection unit 182. The controller 190 includes a function for performing focusing by controlling autofocus units 59, which are provided at the respective exposure heads 166, in accordance with the generated displacement data. Thus, the controller 190 corresponds to the displacement data generation section and the focusing section of the present invention.

Herein, the exposure stage 152, the guides 158, the gate 160, the gate 161, the exposure unit 162 and the detection unit 180 are structured so as to be accommodated inside a casing 110, and the photosensitive material 150 is exposed without being affected by external light.

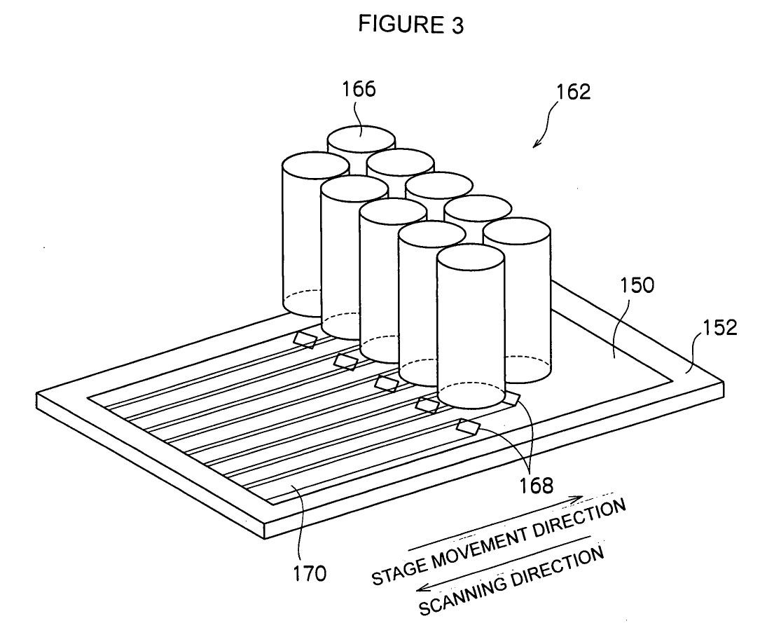

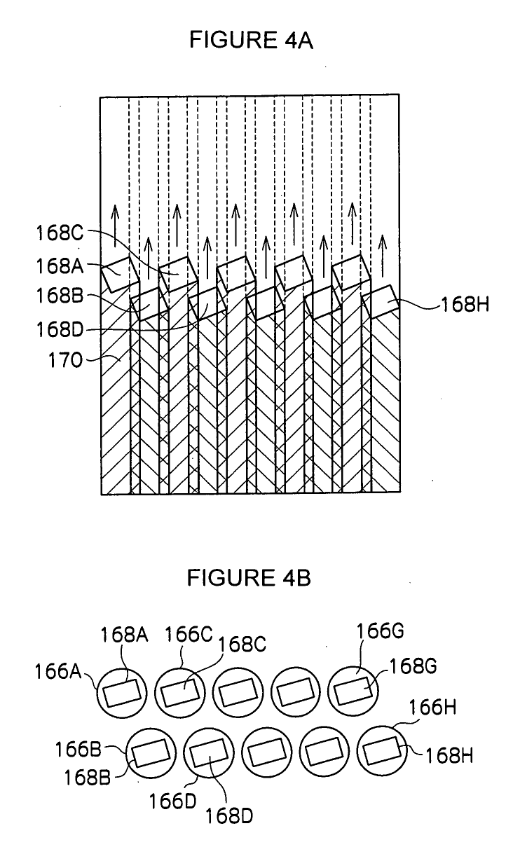

As shown in FIGS. 3 and 4B, the exposure unit 162 is provided with the plurality of exposure heads 166, which are arranged substantially in a matrix pattern of m columns and n rows (for example, two columns and four rows).

As shown in FIG. 3, exposure regions 168, which are regions exposed by the exposure heads 166, have rectangular shapes with short sides thereof in a scanning direction, and are inclined by a predetermined inclination angle θ with respect to the scanning direction. Hence, in accordance with movement of the exposure stage 152, band-form exposed regions 170 are formed at the photosensitive material 150 by the respective exposure heads 166. Note that, as shown in FIGS. 1 and 3, the scanning direction and the stage movement direction are opposite directions.

As shown in FIGS. 4A and 4B, in each row, the respective exposure heads 166, which are arranged in a line, are disposed to be offset by a predetermined interval in a row arrangement direction (which interval is an integer multiple (one in the present embodiment) of the long dimension of the exposure regions), such that each of the band-form exposed regions 170 will be partially superposed with the neighboring exposed regions 170. Consequently, a portion that cannot be exposed between, for example, an exposure region 168A disposed at a leftmost side of a first column and an exposure region 168C disposed neighboring the exposure region 168A at the right thereof will be covered by an exposure region 168B disposed at the leftmost side of the second column. Similarly, a portion that cannot be exposed between the exposure region 168B and an exposure region 168D disposed neighboring the exposure region 168B at the right thereof will be covered by the exposure region 168C. Herein, the exposure region 168A is exposed by exposure head 166A and the exposure region 168B is exposed by exposure head 166B. Similarly, the exposure region 168C and exposure regions 168D, 168E, 168F, 168G and 168H are exposed by exposure heads 166C, 166D, 166E, 166F, 166G and 166H, respectively.

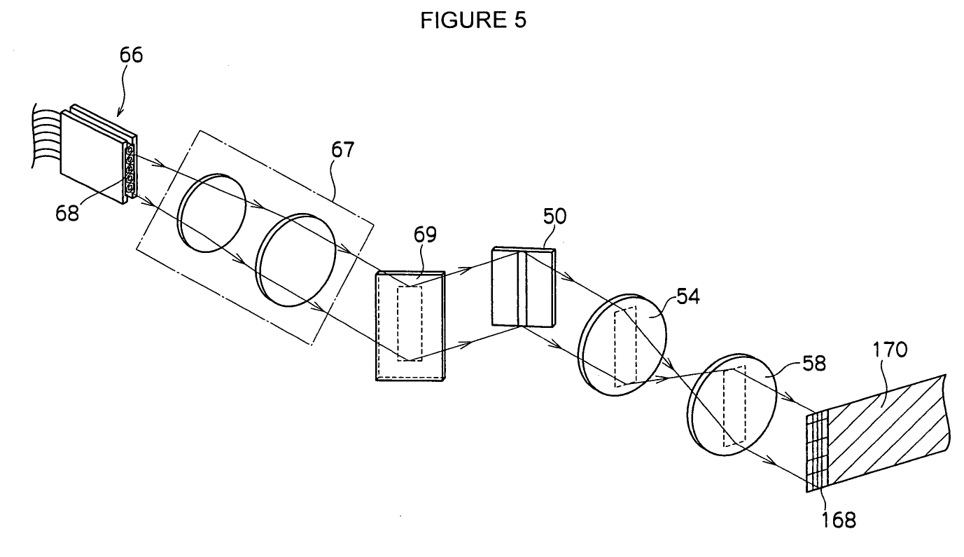

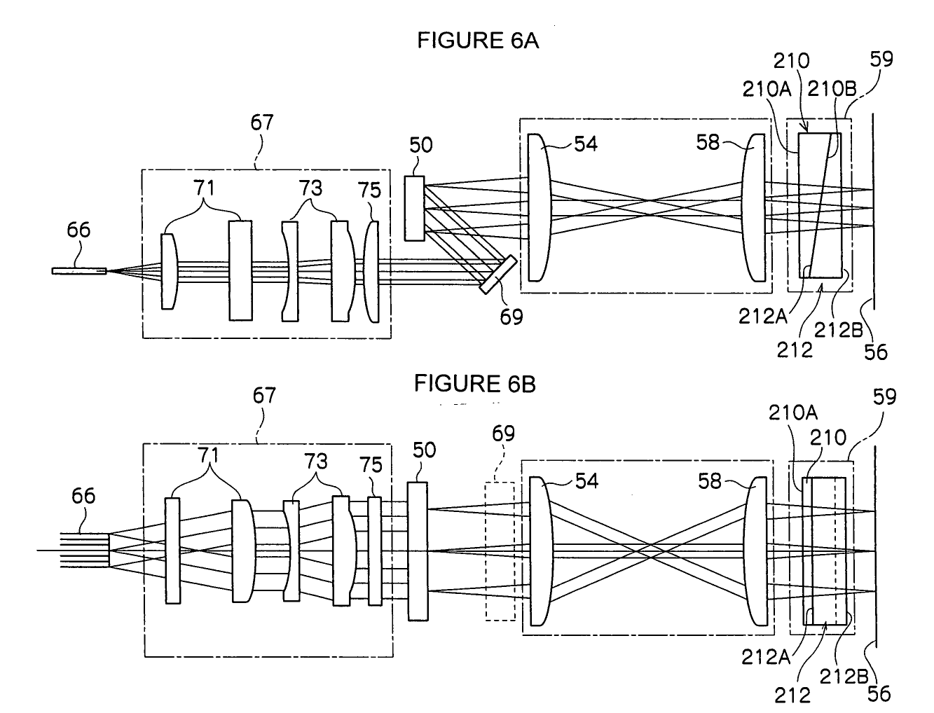

As shown in FIG. 5 and FIGS. 6A and 6B, each of the exposure heads 166A to 166H serves as a spatial light modulator for modulating an incident light beam at each of pixels in accordance with image data, and is equipped with a digital micromirror device (DMD) 50. The DMD 50 is connected with the controller 190, which is provided with a data processing section and a mirror driving control section. At the data processing section of the controller 190, control signals are generated, on the basis of inputted image data, for driving control of each micromirror in a region, of the DMD 50 at the exposure head 166, that is to be controlled.

The mirror driving control section controls the angles of the reflection surfaces of the micromirrors of the DMD 50 at each exposure head 166 in accordance with the control signals generated by the image data processing section. Control of the angles of the reflection surfaces will be described later.

A fiber array light source 66, a lens system 67 and a reflection mirror 69 are arranged, in this order, at a light incidence side of the DMD 50. The fiber array light source 66 is provided with a laser emission portion, at which emission end portions (light emission points) of optical fibers are arranged in a row along a direction corresponding to a length direction of an imaging region P. The lens system 67 corrects laser light emitted from the fiber array light source 66 and focuses the laser light on the DMD. The reflection mirror 69 reflects laser light that has passed through the lens system 67 toward the DMD 50.

The lens system 67 is structured with a single pair of combination lenses 71, which make the laser light that has been emitted from the fiber array light source 66 parallel, a single pair of combination lenses 73, which correct the laser light that has been made parallel such that a light amount distribution is more uniform, and a condensing lens 75, which focuses the laser light whose light amount distribution has been corrected onto the DMD. The combination lenses 73 have the functions of, in the direction of arrangement of the laser emission ends, broadening portions of light flux that are close to an optical axis of the lenses and constricting portions of the light flux that are distant from the optical axis, and in a direction intersecting this direction of arrangement, transmitting the light unaltered. Thus, the laser light is corrected such that the light amount distribution is uniform.

A lens system 54 and a lens system 58 are disposed at a light reflection side of the DMD 50. The lens systems 54 and 58 focus the laser light that has been reflected at the DMD 50 onto a scanning surface (an exposure surface) 56 of the photosensitive material 150. The lens systems 54 and 58 are disposed such that the DMD 50 and the exposure surface 56 have a conjugative relationship.

The present embodiment is specified such that, after the laser light emitted from the fiber array light source 66 has been made uniform and is incident on the DMD 50, each pixel is broadened substantially by a factor of five and focused, by the lens system 54 and the lens system 58.

The autofocus unit 59 is further provided at the emission side of the lens system 58. The autofocus unit 59 aligns a focusing point of the laser light emitted from the fiber array light source 66 with the exposure surface 56. The autofocus unit 59 corresponds to the focusing section of the present invention.

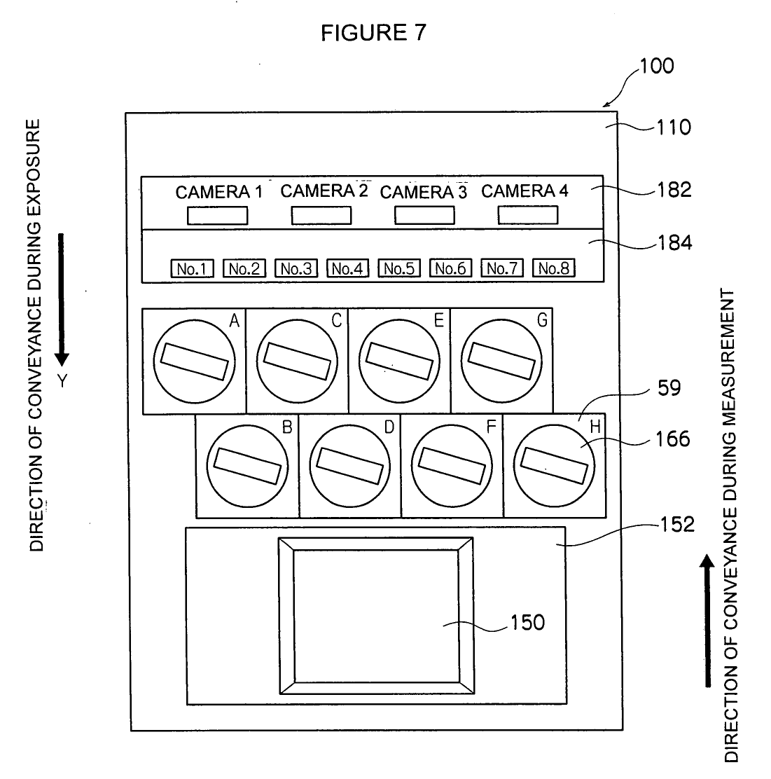

FIG. 7 shows relative positional relationships of the exposure head 166, the alignment detection unit 182 and the displacement measurement unit 184, viewed from above. As shown in FIG. 7, the alignment detection unit 182 is formed with four CCD cameras, alignment camera No. 1, alignment camera No. 2, alignment camera No. 3 and alignment camera No. 4, along a width direction of the photosensitive material 150. Alignment camera No. 1 photographs the exposure region 168A and the exposure region 168B, and alignment camera No. 2 photographs the exposure region 168C and the exposure region 168D. Further, alignment camera No. 3 photographs the exposure region 168E and the exposure region 168F, and alignment camera No. 4 photographs the exposure region 168G and the exposure region 168H.

The displacement measurement unit 184 is disposed at a downstream side of the alignment detection unit 182 with respect to a conveyance direction during exposure, which is a Y-axis direction. The displacement measurement unit 184 is structured by laser alignment meters from laser alignment meter No. 1 to laser alignment meter No. 8. The laser alignment meters No. 1 to No. 8 are disposed so as to measure displacements of the exposure regions 168A to 168H, respectively.

Below, the DMD 50 will be described.

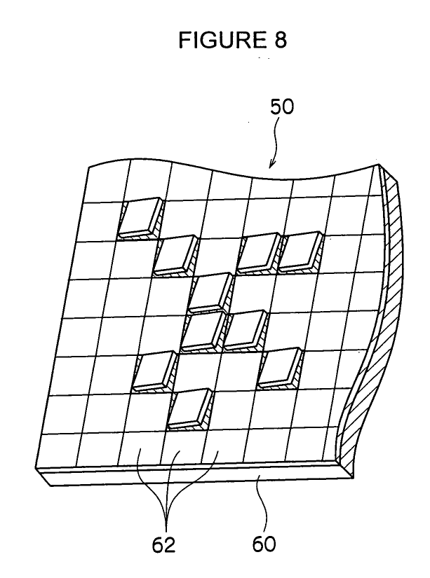

As shown in FIG. 8, at the DMD 50, very small mirrors (micromirrors) 62, which are supported by support columns, are arranged on an SRAM cell (a memory cell) 60. The DMD 50 is a mirror device which is structured with a large number (for example, 1024 by 768, with a pitch of 13.68 μm) of these extremely small mirrors, which structure image elements (pixels), arranged in a checkerboard pattern. At each pixel, the micromirror 62 is provided so as to be supported at an uppermost portion of the support column. A material with high reflectivity, such as aluminium or the like, is applied by vapor deposition at a surface of the micromirror 62. Here, the reflectivity of the micromirror 62 is at least 90%. The SRAM cell 60 with CMOS silicon gates, which is fabricated by a usual semiconductor memory production line, is disposed directly under the micromirror 62, with the support column, which includes a hinge and a yoke, interposed therebetween. Overall, this structure is monolithic (an integrated form).

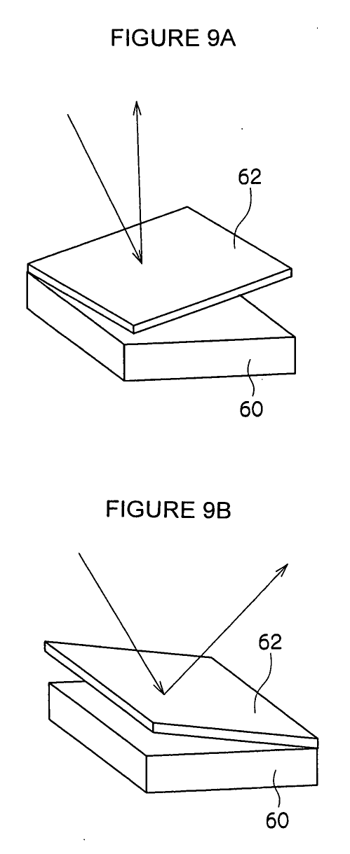

When digital signals representing inclination states (modulation states) of the micromirrors 62 are written to the SRAM cell 60 of the DMD 50, and digital signals are outputted from the SRAM cell 60 to the micromirrors 62, the micromirrors 62 supported at the support columns are inclined, about a diagonal, within a range of ±α° (for example, ±10°) relative to a side of a substrate on which the DMD 50 is disposed. FIG. 9A shows a state in which the micromirror 62 is inclined at +α°, which is an ‘on’ state, and FIG. 9B shows a state in which the micromirror 62 is inclined at −α°, which is an ‘off’ state. Accordingly, as a result of control of the inclinations of the micromirrors 62 at the pixels of the DMD 50 in accordance with image signals, as shown in FIGS. 9A and 9B, light that is incident at the DMD 50 is reflected in directions of inclination of the respective micromirrors 62.

FIG. 8 shows a portion of the DMD 50 enlarged, and shows an example of a state in which the micromirrors 62 are controlled to +α° and −α°. The on-off control of the respective micromirrors 62 is carried out by the controller 190 connected to the DMD 50. A light-absorbing body (which is not shown) is disposed in the direction in which light beams are reflected by the micromirrors 62 that are in the off state.

Next, the autofocus unit 59 will be described.

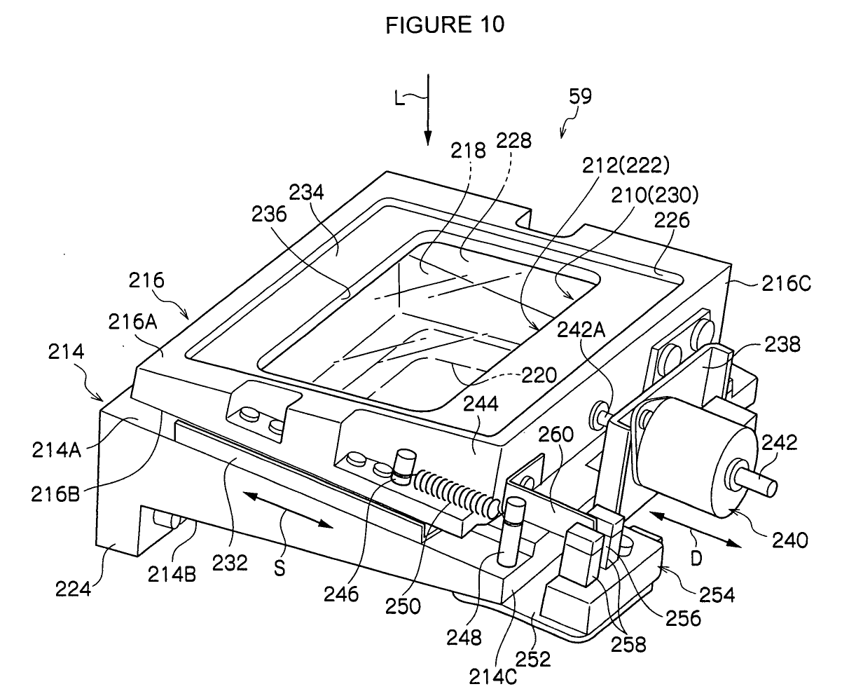

As shown in FIG. 10, the autofocus unit 59 is equipped with paired glass wedges 210 and 212, which are a pair of glass members formed in wedge shapes (trapezoid prism shapes) of a transparent glass material. In the present embodiment, the paired glass wedges 210 and 212 are specified with a refractive index n=1.53, and are disposed adjacent to one another along an optical axis of the laser light, with mutually opposite orientations. The paired glass wedges 210 and 212 correspond to wedge-form optical members of the present invention.

Of the pair of paired glass wedges 210 and 212, the paired glass wedge 210 is arranged at the side of incidence of the laser light (the DMD 50 side). Further, a face of the paired glass wedge 210 at a side which is formed perpendicularly to two side faces thereof serves as the face of the side at which laser light is incident, that is, a light incidence face 210A. The light incidence face 210A is arranged so as to be perpendicular with respect to the direction of incidence of the laser light. Correspondingly, a face of a side of the paired glass wedge 210 which is opposite from the light incidence face 210A serves as a light emission face 210B, from which the laser light is emitted. The light emission face 210B is angled relative to the side faces of the paired glass wedge 210.

The paired glass wedge 212 is adjacent to the paired glass wedge 210 and is disposed at a laser light emission side (the exposure surface 56 side) thereof. The paired glass wedge 212 is arranged such that a face thereof at a side which is angled with respect to two side faces thereof serves as a light incidence face 212A, and a side which is perpendicular to the two side faces serves as a light emission face 212B. Thus, the light emission face 212B of the paired glass wedge 212 is substantially perpendicular to the optical axis of the laser light and the light incidence face 212A is arranged at an inclined orientation.

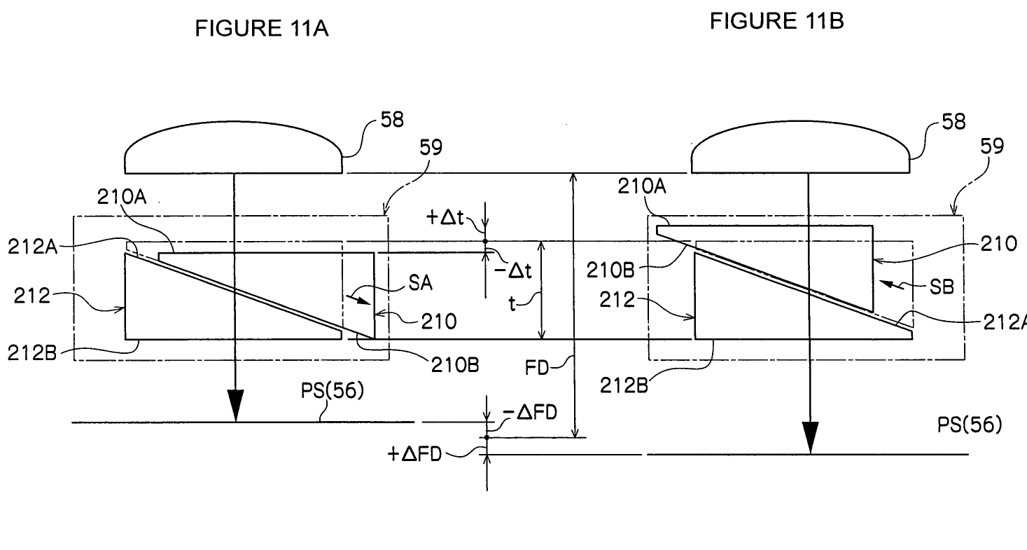

In a non-contacting state of the paired glass wedges 210 and 212, in which, as shown in FIGS. 11A and 11B, the light emission face 210B of the paired glass wedge 210 and the light incidence face 212A of the paired glass wedge 212 form a small gap therebetween, the light incidence face 210A of the paired glass wedge 210 and the light emission face 212B of the paired glass wedge 212 are parallel and are substantially perpendicular to the optical axis of the laser light as mentioned above. In the present embodiment, the gap between the light emission face 210B of the paired glass wedge 210 and the light incidence face 212A of the paired glass wedge 212 is set to 0.1 mm.

As shown in FIG. 10, the autofocus unit 59 is equipped with a base holder 214 and a sliding holder 216, which respectively separately retain the two paired glass wedges 210 and 212. The base holder 214 and the sliding holder 216 correspond to an optical member support portion of the present invention. The paired glass wedge 212 is retained by the base holder 214 and the paired glass wedge 210 is retained by the 216.

The base holder 214 is formed in a wedge shape with a form substantially similar to the paired glass wedge 212. Rectangular aperture portions 218 and 220 are formed in an upper face (inclined face) 214A and a lower face 214B of the base holder 214. A cavity portion (accommodation portion) 222 for accommodating the paired glass wedge 212 is formed inside the base holder 214.

The cavity portion 222 has a recessed form, which is hollowed in from the upper face 214A side of the base holder 214, with the size of the aperture portion 218 and a predetermined depth dimension substantially perpendicularly downward. The paired glass wedge 212 is accommodated inside the cavity portion 222. The cavity portion 222 is formed such that, when the paired glass wedge 212 is accommodated inside the cavity portion 222, a lower face and interior periphery faces of the cavity portion 222 touch a lower face (i.e., the light emission face 212B) and outer periphery faces of the paired glass wedge 212, substantially without gaps.

The aperture portion 220 is formed at a central portion of the lower face 214B of the base holder 214. The aperture portion 220 is formed to be a little smaller than the opening forms of the aperture portion 218 of the upper face 214A and the cavity portion 222. At a left side end portion of the lower face 214B, a fixing portion 224 is protrudingly provided for fixing the autofocus unit 59 as a whole to a frame (not shown) of the exposure unit 162, by screw-fastening.

The sliding holder 216 is formed in a wedge shape with a form substantially similar to the paired glass wedge 210. Rectangular aperture portions 226 and 228 are formed in, respectively, an upper face 216A and a lower face 216B of the sliding holder 216. The sliding holder 216 is a substantially frame-like member inside which a cavity portion (accommodation portion) 230 for accommodating the paired glass wedge 210 is formed. Here, the lower face 216B is an inclined face.

The cavity portion 230 is the same size as the aperture portion 226, and has the form of a through-hole penetrating toward the aperture portion 228. The cavity portion 230 is formed with a size such that, when the paired glass wedge 210 is accommodated, interior periphery faces of the cavity portion 230 touch outer periphery faces of the paired glass wedge 210, substantially without gaps.

A paired glass wedge-restraining plate 234 with a rectangular frame form is fitted in at the aperture portion 226 of the sliding holder 216. Thus, the paired glass wedge 210 is mounted so as to not fall out from the cavity portion 230. A rectangular aperture portion 236 is formed substantially at the middle of the paired glass wedge-restraining plate 234. The aperture portion 236 is substantially the same size as the aperture portion 220 at the lower face 214B side of the base holder 214. When the sliding holder 216 has been moved to a position of mounting of the paired glass wedge 210, the aperture portion 236 is disposed at a position which is substantially superposed with the aperture portion 220.

As shown in FIG. 10, the sliding holder 216 is disposed on the base holder 214 such that the lower face 216B is fitted to face the upper face 214A of the base holder 214 with a direction of inclination of the lower face 216B being opposite to a direction of inclination of the upper face 214A of the base holder 214. Then, the sliding holder 216 is assembled to the base holder 214 by a pair of guide rails 232, which are provided between the upper face 214A of the base holder 214 and the lower face 216B of the sliding holder 216, thus forming a unit.

The sliding holder 216 is disposed to be substantially parallel with the base holder 214, with a predetermined gap therebetween, by the pair of guide rails 232. The sliding holder 216 is assembled to the base holder 214 to be relatively movable in a substantially left-right direction (the direction of arrow S in FIG. 10) along the direction of inclination of the lower face 216B and the upper face 214A.

In order to assemble the paired glass wedges 210 and 212 and the paired glass wedge-restraining plate 234 to the base holder 214 and sliding holder 216, the sliding holder 216 may be moved to a position for assembly of the paired glass wedges 210 and 212, the cavity portion 230 of the sliding holder 216 aligned with the cavity portion 222 of the base holder 214, and the paired glass wedge 212, paired glass wedge 210 and paired glass wedge-restraining plate 234 assembled, in this order from below to above, into the cavity portion 222 and the cavity portion 230.

As shown in FIG. 10, an actuator mounting plate 238 is fixed by screw-fastening at a substantially central position of a right side face 214C of the base holder 214. The right side face 214C of the base holder 214 is formed to be substantially perpendicular to the upper face 214A. The actuator mounting plate 238 which is assembled to this right side face 214C protrudes upward from a mounting portion (lower portion), with an orientation which is substantially perpendicular to the upper face 214A of the base holder 214. A focusing motor 240 is mounted at an outer side face of an upper portion of the actuator mounting plate 238. The focusing motor 240 corresponds to an optical member traversal section of the present invention.

A direction of protrusion and a direction of movement (the direction of arrow D) of a driving shaft 242 of the focusing motor 240 is matched with the movement direction (the direction of arrow S) of the sliding holder 216, and the focusing motor 240 is assembled to the actuator mounting plate 238. A distal end portion 242A of the driving shaft 242 is coupled to a right side face 216C of the sliding holder 216. The focusing motor 240 is also connected to a focusing mechanism control section of the controller 190, and is controlled for operation by this focusing mechanism control section.

A cutaway portion 244 is formed at a front-right corner portion of the upper face 216A of the sliding holder 216. A pair of support pillars 246 and 248 are provided at a lower face of this cutaway portion 244 and a front-right corner portion of the upper face 214A of the base holder 214, respectively. A tension coil spring 250, whose spring force is set to be smaller than a driving force of the driving shaft 242 of the focusing motor 240, spans between the pair of support pillars 246 and 248. A pre-load is applied between the sliding holder 216 and the base holder 214, which are coupled by the actuator mounting plate 238 and the focusing motor 240, by this spring force of the tension coil spring 250.

When the focusing motor 240 is operated, consequent to signals from a later-described head control section of the controller 190, and the driving shaft 242 is moved in the direction of arrow D, the sliding holder 216 and the paired glass wedge 210 move in the direction of arrow S, guided by the pair of guide rails 232. Even if there is a little play (looseness) at the driving shaft 242 of the focusing motor 240, or at the guide rails 232 or the like, the sliding holder 216 and the paired glass wedge 210 are retained to be free of looseness in a rest state by the pre-load applied by the tension coil spring 250. Furthermore, the sliding holder 216 and the paired glass wedge 210 operate smoothly during movements.

A rectangular sensor mounting plate 252 is fixed by screw-fastening at a front-right corner portion of the lower face 214B of the base holder 214. A protruding right side portion of the sensor mounting plate 252 extends rightward from a portion of mounting to the lower face 214B of the base holder 214 (a left side portion of the sensor mounting plate 252). This right side portion is inflected relative to the portion of mounting so as to be substantially parallel with the upper face 214A of the base holder 214. A reference position sensor unit 254 is mounted at an upper face of the right side portion of the sensor mounting plate 252, for detecting a reference position (i.e., a home position) of the sliding holder 216 at which the paired glass wedge 210 is retained.

At the reference position sensor unit 254, an optical sensor 258 is mounted at an upper portion of a unit main body, which is formed in a cuboid shape. The reference position sensor unit 254 is provided with a circuit board (not shown), which amplifies electronic signals (detection signals), which are outputted from the optical sensor 258 into the unit main body. At the optical sensor 258, a light projecting-receiving element (not shown) is provided at an inner wall face of a slit portion 256. The optical sensor 258 is arranged such that the slit portion 256 is oriented to be substantially parallel with the movement direction of the sliding holder 216 (the direction of arrow S). Further, the reference position sensor unit 254 is connected to the head control section of the controller 190.

At a front end portion of the right side face 216C of the sliding holder 216, a reference position detection plate 260, to correspond with the reference position sensor unit 254, is fixed by screw-fastening. The reference position detection plate 260 is ‘L’-shaped and is inflected substantially perpendicularly from a portion for mounting to the right side face 216C of the sliding holder 216 (a left side portion of the reference position detection plate 260). A right side portion of the reference position detection plate 260, which extends rightward with a predetermined length dimension, is a detection portion (a light sensor-shading portion). The reference position detection plate 260 is arranged at a position at which it is capable, in accordance with movement of the sliding holder 216, of passing into the slit portion 256 of the optical sensor 258 and of withdrawing from the slit portion 256.

When the distal end of the detection portion of the reference position detection plate 260 is moved into the slit portion 256 and withdrawn from the slit portion 256 in accordance with movements of the sliding holder 216, the optical sensor 258 outputs high and low detection signals in accordance with respective states of detection of a light-blocking state and a light-non-blocking state according to the light projecting-receiving element. Hence, the reference position sensor unit 254 amplifies these detection signals with the circuit board and outputs the detection signals to the head control section of the controller 190.

A position of switching of the output level of a detection signal inputted from the reference position sensor unit 254 between high and low, when the head control section of the controller 190 controls for driving the focusing motor 240 and the sliding holder 216 is moved, is verified as a reference position of the sliding holder 216 and the paired glass wedge 210. Information of this reference position is stored in memory. Hence, for driving control of the focusing motor 240, control signals which control driving of the focusing motor 240 are generated in accordance with the reference position information, control signals for applying correction to the reference position information are generated as necessary, and these signals are outputted to the focusing motor 240.

When the focusing motor 240 of the autofocus unit 59 is controlled for driving by signals from the controller 190, the paired glass wedge 210 retained at the sliding holder 216 moves, as shown in FIGS. 11A and 11B, from the reference position shown by broken lines in the drawings, in the direction of arrow SA shown in FIG. 11A or the direction of arrow SB shown in FIG. 11B.

Now, when the paired glass wedge 210 is at the reference position, a distance between the light incidence face 210A of the paired glass wedge 210 and the light emission face 212B of the paired glass wedge 212, that is, a total thickness dimension of the paired glass wedges 210 and 212 including the small gap formed therebetween, is ‘t’. Hence, the thickness dimension t decreases by Δt (changes by −Δt) when the paired glass wedge 210 moves a certain distance from the reference position in the direction of arrow SA, and increases by Δt (changes by +Δt) when the paired glass wedge 210 moves the certain distance from the reference position in the direction of arrow SB.

When the thickness dimension t of the paired glass wedges 210 and 212 changes thus (by ±Δt), a transmission distance of the laser light passing through the paired glass wedges 210 and 212 changes, and a focusing distance of the laser light FD changes (by ±ΔFD). Here, the planes PS shown in FIGS. 11A and 11B represent focusing planes.

If the refractive index of the paired glass wedges 210 and 212 is ‘n’ (n=1.53 in the present embodiment), amounts of changes in the focusing distance FD of the laser light corresponding to amounts of changes in the thickness dimension t of the paired glass wedges 210 and 212 can be found by the following equations.
+ΔFD=+Δt−(+Δt)/n
−ΔFD=−Δt−(−Δt)/n

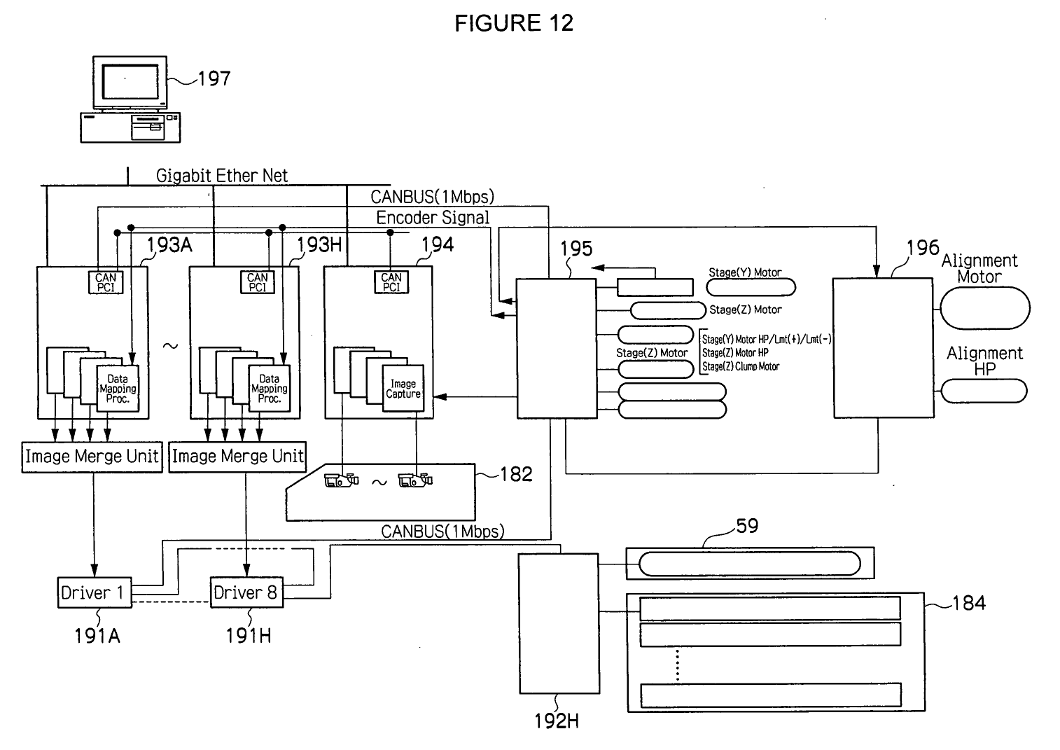

Below, structure of the controller 190 will be described with reference to FIG. 12.

The controller 190 features functions for controlling the exposure device 100 in accordance with inputs from a control computer 197, and is constituted with the following units.

A. Exposure head driving units 191A, 191B, 191C, 191D, 191E, 191F, 191G and 191H, for driving the exposure heads 166A to 166H.

B. Image processing units 193A, 193B, 193C, 193D, 193E, 193F, 193G and 193H, for dividing image data inputted from the control computer 197 into image data of images that are to be exposed at the eight exposure regions 168A to 168H, and for inputting the divided image data to the exposure head driving units 191A to 191H, respectively.

C. An alignment measurement unit 194, for processing image data from the alignment cameras Nos. 1 to 4, which are provided at the alignment detection unit 182, and inputting the processed image data to a main control unit, which will be described later.

D. An alignment adjustment unit 196, for adjusting alignment of the exposure stage 152 on the basis of alignment data obtained by the alignment measurement unit 194.

E. Focusing control units 192A, 192B, 192C, 192D, 192E, 192F, 192G and 192H, provided at the exposure head driving units 191A to 191H, respectively, for controlling the autofocus units 59 on the basis of displacement measurement results, from the laser displacement meters provided at the displacement measurement unit 184, and suchlike.

F. A main control unit 195, which adjusts alignment of the exposure stage 152, via the alignment adjustment unit 196, in accordance with inputs of image data from the alignment measurement unit 194, controls lifting and Y-axis direction conveyance of the exposure stage 152, and controls the exposure head driving units 191A to 191H via the image processing units 193A to 193H.

CANPCIs are provided at the image processing units 193A to 193H and the alignment measurement unit 194. The CANPCIs mutually exchange data between the image processing units 193A to 193H and the alignment measurement unit 194 and, at the same time, send and receive data, instructions and the like to and from the main control unit 195.

Instructions and data from the control computer 197 are inputted, through the CANPCIs provided at the image processing units 193A to 193H and the alignment measurement unit 194, to the main control unit 195.

(2) Operation of the Exposure Device 100

Below, a sequence of operations from setting of the photosensitive material 150 at the exposure device 100 to completion of exposure will be described.

### (2-1) EXAMPLE 1

The photosensitive material 150 is placed at the exposure stage 152 in a state in which the exposure stage 152 is at the position shown in FIG. 1. When an operator inputs an instruction to commence exposure, a command to the effect that the exposure stage 152 should be moved in a measurement direction while the alignment detection unit 182 and the displacement measurement unit 184 are started up is inputted from the control computer 197 provided at the controller 190 to the main control unit 195.

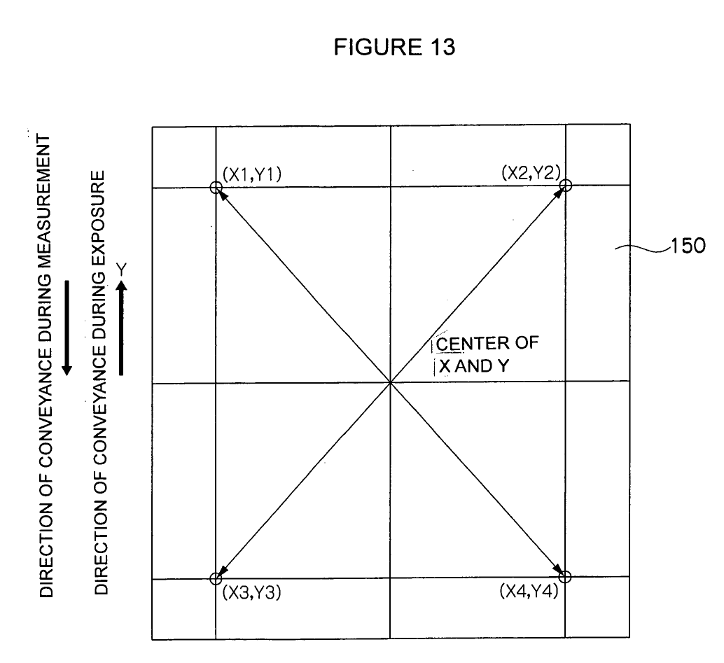

When this command is inputted to the main control unit 195, the alignment cameras Nos. 1 to 4 at the alignment detection unit 182 are activated, and measurements of position co-ordinates of a reference hole (X1,Y1), a reference hole (X2,Y2), a reference hole (X3,Y3) and a reference hole (X4,Y4) formed at the photosensitive material 150 are performed. At the same time, the laser displacement meters Nos. 1 to 8 at the displacement measurement unit 184 are started up, and measurements of displacements of the exposure surface of the photosensitive material 150 are performed. Note that an example of the reference hole (X1,Y1), the reference hole (X2,Y2), the reference hole (X3,Y3) and the reference hole (X4,Y4) formed at the photosensitive material 150 is shown in FIG. 13.

The results of measurements of displacement measured by the laser displacement meters Nos. 1 to 8 are inputted to the focusing control units 192A to 192H, respectively. The results of measurement of the position co-ordinates of the reference hole (X1,Y1), the reference hole (X2,Y2), the reference hole (X3,Y3) and the reference hole (X4,Y4) are inputted to the main control unit 195 via the CANPCIs of the alignment measurement unit 194 and the image processing unit 193A, and are inputted from the main control unit 195 to the focusing control units 192A to 192H via the exposure head driving units 191A to 191H.

If a user has inputted X and Y co-ordinates of the reference hole (X1,Y1), the reference hole (X2,Y2), the reference hole (X3,Y3) and the reference hole (X4,Y4) at the control computer 197 beforehand, these X and Y co-ordinates are also inputted to the focusing control units 192A to 192H.

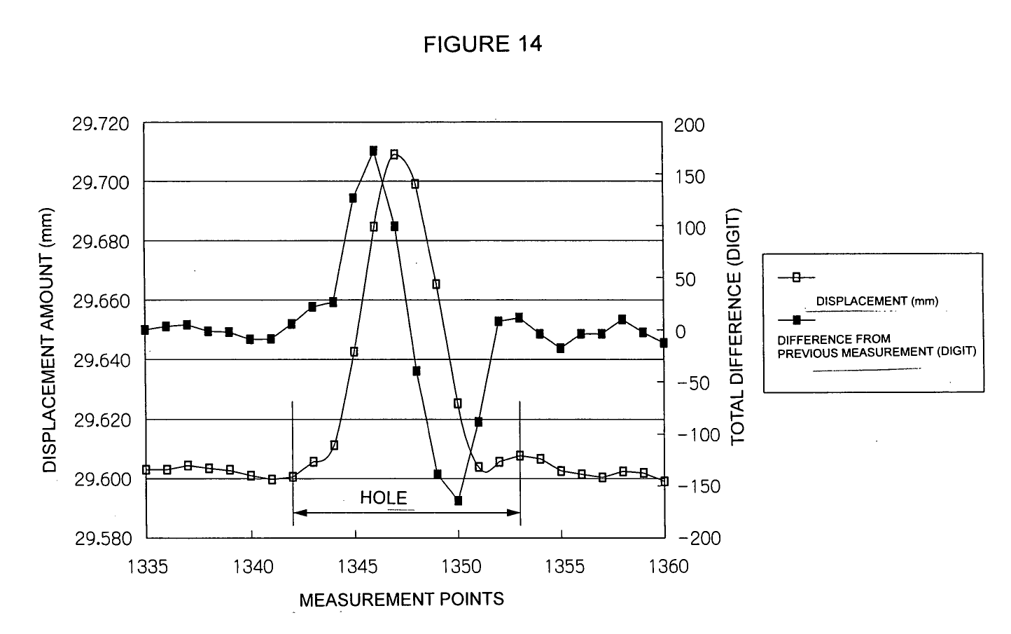

At the focusing control units 192A to 192H, from the displacement data measured by the laser displacement meters Nos. 1 to 8, differences between the displacement data and displacement data of previous measurements are found. Then, as shown in FIG. 14, when a difference from the previous data is more than a predetermined value for two or more successive cycles, for example, when differences of more than +100 digit occur, it is judged that there is a step in the photosensitive material 150, and this displacement data is considered to possibly be a reference hole.

Next, a range of the hole is determined from the displacement data. As a specific example, to start, a point corresponding to displacement data three points previous from a position at which a difference of +100 digit or more occurs is considered to be the beginning of a hole and, to finish, a point corresponding to displacement data three points subsequent from a position at which a difference of +100 digit or more occurs is considered to be the end of the hole.

Y co-ordinates of a hole are found from the data, in which points corresponding to the start and end of the hole are represented by counts of points from an origin point, and a spacing between any two adjacent measurement points. X co-ordinates are found from mounting positions of the laser displacement meters Nos. 1 to 8.

Thereafter, the X co-ordinates and Y co-ordinates of the holes which have been found thus are compared with the position co-ordinates of the reference hole (X1,Y1), the reference hole (X2,Y2), the reference hole (X3,Y3) and the reference hole (X4,Y4) which have been measured at the alignment detection unit 182 and the position co-ordinates of the same which have been inputted by the user. Then, when these three match, it is judged that the steps detected by the laser displacement meters Nos. 1 to 8 are one or other of the reference hole (X1,Y1), the reference hole (X2,Y2), the reference hole (X3,Y3) and the reference hole (X4,Y4).

When the focusing control units 192A to 192H determines that step are one or other of the reference hole (X1,Y1), the reference hole (X2,Y2), the reference hole (X3,Y3) and the reference hole (X4,Y4), similarly to the determination of the start and end of the hole, a range from the point corresponding to displacement data three points previous to the position at which a difference of +100 digit or more initially occurs to the point corresponding to displacement data three points subsequent to the position at which a difference of +100 digit or more finally occurs is treated as a range across which these two points are joined by a straight line. In addition, the data obtained by the laser displacement meters Nos. 1 to 8 is subjected to moving average processing to remove a noise component. Thus, a focusing map is generated for each of the exposure regions 168A to 168H.

At the focusing control units 192A to 192H, the focusing motors 240 of the autofocus units 59 at the exposure heads 166A to 166H are driven to perform focusing in accordance with the focusing maps which are generated for each of the exposure regions 168A to 168H by the procedure described above.

Thus, in the exposure device 100 relating to the present embodiment, it is determined that positions at which the three sets of data—reference hole positions measured by the alignment cameras, measurement values from the laser displacement meters, and data inputted to the control computer by a user—match are hole positions. When a hole is detected, then, for example, the hole is excluded in creating a focusing map, displacement data of a hole portion is subjected to moving average processing and recreated as new displacement data, and focusing is carried out in accordance with this focusing map. Consequently, there will be no error in focusing positions of laser light from the exposure heads 166. As a result, a sharp image free of mis-focusing will be obtained.

### (2-2) EXAMPLE 2

The photosensitive material 150 is placed at the exposure stage 152 in a state in which the exposure stage 152 is at the position shown in FIG. 1. When an operator inputs an instruction to commence exposure, a command to the effect that the exposure stage 152 should be moved in the measurement direction while the displacement measurement unit 184 is started up is inputted from the control computer 197 provided at the controller 190 to the main control unit 195.

When this command is inputted to the main control unit 195, the laser displacement meters Nos. 1 to 8 at the displacement measurement unit 184 are started up, and measurements of displacements of the exposure surface of the photosensitive material 150 are performed.

The results of measurement of displacements measured by the laser displacement meters Nos. 1 to 8 are inputted to the focusing control units 192A to 192H, respectively.

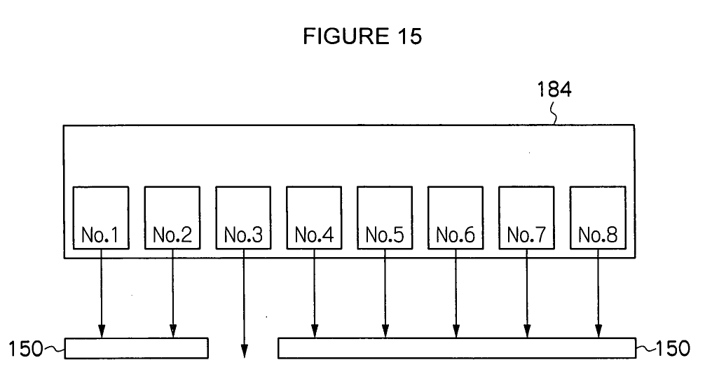

FIG. 15 is a side view showing a relationship between the photosensitive material 150 and the laser displacement meters Nos. 1 to 8 during displacement measurement.

At the focusing control units 192A to 192H, from the displacement data measured by the laser displacement meters Nos. 1 to 8, differences between neighboring data, which is displacement data measured at the same time by neighboring laser displacement meters, are found. Then, when a difference between neighboring data is more than a predetermined value, for example, when a difference of more than +100 digit occurs, it is judged that there is a step in the photosensitive material 150, and this displacement data is considered to possibly be a hole.

Next, a range of the hole is determined from the displacement data. Specifically, differences, such as a difference between the laser displacement meter No. 1 and the laser displacement meter No. 2 and a difference between the laser displacement meter No. 2 and the laser displacement meter No. 3, are progressively calculated. To start, a point corresponding to displacement data at a position at which a difference of +100 digit or more occurs is considered to be the beginning of a hole and, to finish, a point corresponding to displacement data at a position at which a difference of +100 digit or more occurs is considered to be the end of the hole. In FIG. 15, there are differences between No. 2 and No. 3 and between No. 3 and No. 4. Accordingly, No. 3 is judged to be at a hole position.

Y co-ordinates of a hole are found from the data, in which points corresponding to the start and end of the hole are represented by counts of points from an origin point, and a spacing between any two adjacent measurement points. X co-ordinates are found from mounting positions of the laser displacement meters Nos. 1 to 8.

When the focusing control units 192A to 192H determine that step are a hole, similarly to the determination of the start and end of the hole, a range from the point corresponding to the position at which a difference of +100 digit or more initially occurs to the point corresponding to the position at which a difference of +100 digit or more finally occurs is treated as a range across which these two points are joined by a straight line. In addition, data obtained by a laser displacement meter immediately prior to a hole position serves as displacement data of the hole position. Thus, a focusing map is generated for each of the exposure regions 168A to 168H.

At the focusing control units 192A to 192H, the focusing motors 240 of the autofocus units 59 at the exposure heads 166A to 166H are driven to perform focusing in accordance with the focusing maps which are generated for each of the exposure regions 168A to 168H by the procedure described above.

Thus, in the exposure device 100 relating to the present embodiment, determinations of hole positions are carried out on the basis of differences in the measurement data between neighboring laser displacement meters. When a hole is detected, the hole is excluded in creating the focusing map, displacement data of a hole portion is substituted with displacement data of a position peripheral to the hole, and focusing is carried out in accordance with this focusing map. Consequently, there will be no error in focusing positions of laser light from the exposure heads 166. As a result, a sharp image free of mis-focusing will be obtained.

### (2-3) EXAMPLE 3

When a hole is to be formed in the photosensitive material 150, before exposure, an operation is executed to form the hole with a drill, in a substrate machining process. Hole position information at such a time (X-Y co-ordinates) is transmitted to the exposure device from a device such as a raster image processor (RIP) or the like, and is respectively inputted to the focusing control units 192A to 192H. At a position of the hole position information, it is judged that there will be a step in the photosensitive material 150, and it is determined that the displacement data will be a hole.

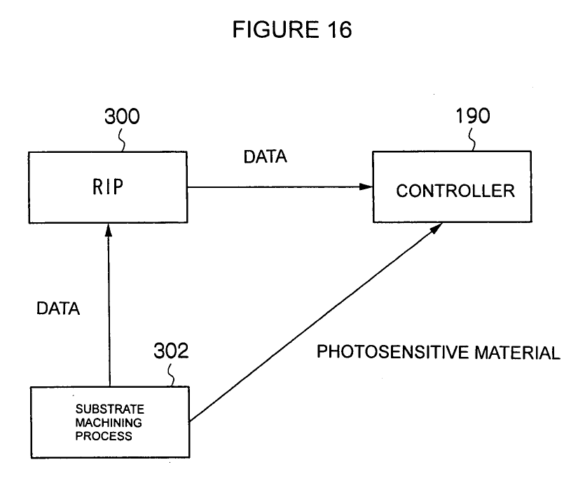

FIG. 16 is a block diagram showing a method for judging hole positions from the substrate machining process.

When operations for forming holes are executed by a drill in a substrate machining process 302, information of hole positions at the photosensitive material 150 is passed to an RIP 300. Thereafter, image data for exposure and the hole position information is transmitted from the RIP 300 to the controller 190 of the exposure device 100 before exposure.

The focusing control units 192A to 192H provided at the exposure device 100 determine the positions of the holes at the photosensitive material 150 from the hole position information that has been transmitted, and create focusing maps for each of the exposure regions 168A to 168H, with displacement data obtained by the laser displacement meters Nos. 1 to 8 immediately prior to the hole positions serving as displacement data for the hole positions.

At the focusing control units 192A to 192H, the focusing motors 240 of the autofocus units 59 at the exposure heads 166A to 166H are driven to perform focusing in accordance with the focusing maps generated for each of the exposure regions 168A to 168H by the procedure described above.

Thus, in the exposure device 100 relating to the present embodiment, determination of hole positions is carried out on the basis of data of hole positions that have been machined in a substrate machining process. When a hole is detected, the hole is excluded in creating a focusing map, displacement data of a hole portion is substituted with displacement data of a position peripheral to the hole, and focusing is carried out in accordance with this focusing map. Consequently, there will be no error in focusing positions of laser light from the exposure heads 166. As a result, a sharp image free of mis-focusing will be obtained.

In the present invention, a hole position identification section may determine the position of a hole in an exposure surface of a photosensitive material on the basis of measurement data of heights of positions of the exposure surface of the photosensitive material from a distance measurement section, which measures the heights of positions of the exposure surface of the photosensitive material. Further, a displacement data generation section may generate displacement data without utilizing the measurement data for the position which is determined to be the position of the hole in the exposure surface of the photosensitive material.

In the present invention, the displacement data generation section may compare the measurement data at a first measurement position according to the distance measurement section with the measurement data at a measurement position near the first measurement position according to the distance measurement section and, if a difference between values of these measurement data exceeds a predetermined value, may correct or disregard the measurement data at the first measurement position according to the distance measurement section.

In the present invention, the hole position identification section may include a hole formation position information acquisition section, which acquires data of an occasion of hole formation in the photosensitive material by a hole formation section, and the disposition data generation section may identify the position of the hole at the photosensitive material on the basis of the data of the occasion of hole formation in the photosensitive material by the hole formation section, and correct or disregard the measurement data at that position.

The present invention may include, in addition to the distance measurement section and the focusing section, a hole co-ordinate measurement section for identifying the position of the hole at the photosensitive material, and, if second measurement data at a second measurement position, which is acquired by the distance measurement section, includes a value equal to or greater than a predetermined value, the displacement data generation section may compare the second measurement position at which the second measurement data is acquired with a hole co-ordinate position obtained by the hole co-ordinate measurement section and, if these two positions coincide, judge that the second measurement position at which the second measurement data is acquired corresponds to the position of the hole at the photosensitive material and, for a predetermined range about the second measurement position, correct or disregard the second measurement data.

At this exposure device, position co-ordinates of holes formed in the photosensitive material are found by the hole co-ordinate measurement section. At the same time, at the displacement data generation section, presence/absence of holes is judged on the basis of the results of displacement measurements at the distance measurement section and the position co-ordinates found by the hole co-ordinate measurement section. When a hole is present, position co-ordinates thereof are identified, displacement measurement values of the hole and surroundings thereof are excluded, and displacement data is generated with displacement amounts which differ from these measured displacement amounts. Hence, the focusing section is controlled on the basis of this displacement data.

Therefore, even with a photosensitive material in which holes are formed, errors will not be included in the displacement data consequent to detection of the holes. As a result, it is possible to accurately align focusing of the light beam(s) from the exposure head(s) with the exposure surface of the photosensitive material.

Alignment cameras, which photograph the photosensitive material to find the positions of reference holes, or the like are examples of the hole co-ordinate measurement section.

The present invention may include, in addition to the distance measurement section and the focusing section, a hole position co-ordinate input section for identification by a user of the position of the hole at the photosensitive material. If third measurement data at a third measurement position, which is acquired by the distance measurement section, includes a value equal to or greater than a predetermined value, the displacement data generation section may compare the third measurement position at which the third measurement data is acquired with a hole co-ordinate position inputted by the user beforehand and, if these two positions coincide, judge that the third measurement position at which the third measurement data is acquired corresponds to the position of the hole at the photosensitive material and, for a predetermined range about the third measurement position, correct or disregard the third measurement data.

At this exposure device, when a hole such as a reference hole or the like is formed in the photosensitive material, at the displacement data generation section, on the basis of the results of measurement of displacement at the distance measurement section and of position co-ordinates of the hole inputted by a user beforehand, displacement measurement values of the hole and surroundings thereof are excluded, and displacement data is generated with displacement amounts which differ from these measured displacement amounts. Hence, the focusing section is controlled on the basis of this displacement data.

Consequently, it is possible to accurately align focusing of the light beam from the exposure head with the exposure surface of the photosensitive material.

Furthermore, in this exposure device, because the section at which the positions of holes that are formed in the photosensitive material are inputted by a user is employed, the hole co-ordinate measurement section can be omitted, and structure can be simplified.

The present invention may include, in addition to the distance measurement section and the focusing section, the hole co-ordinate measurement section for identifying the position of the hole at the photosensitive material and the hole position co-ordinate input section for identification by a user of the position of the hole at the photosensitive material. If fourth measurement data at a fourth measurement position, which is acquired by the distance measurement section, includes a value equal to or greater than a predetermined value, the displacement data generation section may compare the fourth measurement position at which the fourth measurement data is acquired with a hole co-ordinate first position obtained by the hole co-ordinate measurement section and a hole co-ordinate second position inputted by the user beforehand and, if these three positions coincide, judge that the fourth measurement position at which the fourth measurement data is acquired corresponds to the position of the hole at the photosensitive material and, for a predetermined range about the fourth measurement position, correct or disregard the fourth measurement data.

At this exposure device, position co-ordinates of holes formed in the photosensitive material are found by the hole co-ordinate measurement section. At the same time, at the displacement data generation section, presence/absence of holes is judged on the basis of the results of measurement of displacement at the distance measurement section, hole position co-ordinates found by the hole co-ordinate measurement section and hole position co-ordinates inputted by a user. When a hole is present, position co-ordinates thereof are identified.

As a result, judgments of presence/absence of holes and identifications of position co-ordinates are carried out with greater accuracy.

In the present invention, for a predetermined range about a co-ordinate position which is determined to be a hole, the displacement data generation section may specify data which differs from measurement data measured at a measurement position in the range to serve as measurement data peripheral to the co-ordinate position which is determined to be the hole.

At this exposure device, displacement amounts of a predetermined range around a co-ordinate position which is judged to be a hole are set to a displacement amount of the surroundings of the co-ordinate position judged to be a hole.

In the present invention, the displacement data generation section may subject measurement data acquired by the distance measurement section to moving average processing and update the measurement data.

When the displacement data includes noise with high frequency components, it is not preferable to use the raw data for performing focusing with the focusing section.

Accordingly, at this exposure device, high frequency components are removed from the displacement data and processing is performed such that focusing control by the focusing section is more satisfactory.

In the present invention, the focusing section may include: a plurality of optical members disposed at a respective emission side of at least one exposure head structuring an exposure section, the optical members being formed with wedge shapes of light-transmissive material and being arranged adjacent to one another, along an optical axis of a light beam emitted from the exposure head, with mutually opposite orientations; an optical member support section, which supports one optical member of the plurality of optical members to be movable along a face thereof which opposes another optical member of the plurality; and an optical member traversal section, which causes the one optical member to move along the opposing face relative to the other optical member.

In this exposure device, the plurality of wedge-form optical members provided at the focusing section are disposed adjacent to one another on the optical axis of the light beam, with mutually opposite orientations. The one wedge-form optical member is relatively moved with respect to the other wedge-form optical member, along a face thereof which opposes the other wedge-form optical member, by the optical member traversal section. As a result, a relative distance in the optical axis direction of the light beam between an incidence face, at which the light beam is incident on one wedge-form optical member, and a light emission face, from which the light beam which has passed through the plurality of wedge-form optical members after incidence is emitted from another one of the wedge-form optical members, consequently changes. In other words, a transmission path along which the light beam is transmitted through the plurality of wedge-form optical members is altered. As a result, a focusing distance of the light beam changes.

This focusing section has a structure which is simple, and can be compactly structured. Thus, it is easy to incorporate the focusing section at the emission side of each exposure head.

At the exposure device of the present invention, besides the form described hereabove, a structure which changes a distance of the photosensitive material from the exposure head by moving the photosensitive material itself in a focusing depth direction could also be employed as the focusing section.

In the present invention, the exposure head may perform imaging by altering modulation states of respective pixels to turn the pixels on and off in accordance with inputted image information.

At this exposure head, modulation states of pixels are changed to set the pixels to on and off. Therefore, it is not necessary to turn a light source itself on and off to turn the pixels on and off, and the light source can be maintained in an illuminating state during imaging. Accordingly, because a mechanism for turning the light source on and off with a high frequency cycle is not required, it is possible to simplify structure of the exposure head and reduce the frequency of breakdowns. Further, the pixels can be set to on and off more rapidly than in a case of turning a light source on and off directly. Therefore, a better quality image can be obtained. Further yet, it is easier to perform imaging onto the whole of a photosensitive material with a large surface area.

The present invention may include: measuring heights of positions of the exposure surface of the photosensitive material; and determining the position of the hole in the exposure surface of the photosensitive material on the basis of measurement data of the heights of positions of the exposure surface of the photosensitive material, with a step of generating displacement data generating the displacement data without utilizing the measurement data for the position which is determined to be the position of the hole in the exposure surface of the photosensitive material.

The present invention may include: comparing the measurement data at a first measurement position with the measurement data at a measurement position near the first measurement position; and, if a difference between values of these measurement data exceeds a predetermined value, one of correcting and disregarding the measurement data at the first measurement position.

The present invention may include: performing identification of the hole position by acquiring data of an occasion of hole formation in the photosensitive material; identifying the position of the hole at the photosensitive material on the basis of the data of the occasion of hole formation in the photosensitive material; and one of correcting and disregarding the measurement data at that position.

The present invention may include, if second measurement data at a second measurement position includes a value equal to or greater than a predetermined value: comparing the second measurement position at which the second measurement data is acquired with a hole co-ordinate position obtained by measurement of a hole co-ordinate; and, if these two positions coincide, judging that the second measurement position at which the second measurement data is acquired corresponds to the position of the hole at the photosensitive material and, for a predetermined range about the second measurement position, one of correcting and disregarding the second measurement data.

In the exposure process too, when a hole formed in the photosensitive material is detected, the displacement data is generated with the hole and surroundings thereof excluded, and focusing is performed on the basis of this displacement data. Thus, even in a case in which holes are formed in the photosensitive material, it is possible to expose in a state in which focusing of laser light from an exposure head is precisely fitted to the exposure surface of the photosensitive material.

The present invention may include, if third measurement data at a third measurement position includes a value equal to or greater than a predetermined value: comparing the third measurement position at which the third measurement data is acquired with a hole co-ordinate position inputted by a user beforehand; and, if these two positions coincide, judging that the third measurement position at which the third measurement data is acquired corresponds to the position of the hole at the photosensitive material and, for a predetermined range about the third measurement position, one of correcting and disregarding the third measurement data.

In this exposure process, instead of providing a hole co-ordinate measurement step for finding co-ordinates of holes formed in the photosensitive material, hole co-ordinates which have been inputted beforehand by a user are employed for identifying presence/absence and positions of holes in the photosensitive material.

Therefore, for this exposure process, an exposure device whose structure is simplified can be employed.

The present invention may include, if fourth measurement data at a fourth measurement position includes a value equal to or greater than a predetermined value: comparing the fourth measurement position at which the fourth measurement data is acquired with a hole co-ordinate first position and a hole co-ordinate second position, which is inputted by a user beforehand; and, if these three positions coincide, judging that the fourth measurement position at which the fourth measurement data is acquired corresponds to the position of the hole at the photosensitive material and, for a predetermined range about the fourth measurement position, one of correcting and disregarding the fourth measurement data.

In this exposure process, the presence/absence of holes is judged on the basis of displacement measurement results, hole position co-ordinates, and hole co-ordinate positions inputted by a user. When a hole is present, position co-ordinates thereof are identified.

As a result, judgments of the presence/absence of holes and identifications of position co-ordinates can be performed with higher accuracy.

According to the present invention as described above, an exposure device and exposure process which are capable of exposure which is accurately focused on a photosensitive material, even when holes are formed in the photosensitive material and/or grooves or the like are formed, are provided.

Hereabove, an exposure device of the present invention has been described in detail. However, the present invention is not limited to the embodiment described above. Naturally, various modifications and alterations may be implemented within a scope which does not depart from the spirit of the present invention.

What is claimed is:

1. An exposure device for exposing a photosensitive material with an exposure section which emits a light beam modulated in accordance with image data while the photosensitive material is relatively moved, the exposure device comprising:
a hole position identification section, which determines a position of a hole in an exposure surface of the photosensitive material;
a focusing section, which performs focusing control for causing a focusing position of the light beam from the exposure section to coincide with the exposure surface; and
a displacement data generation section, which generates displacement data for the focusing control by the focusing section, excluding a position which is determined, on the basis of results of determination by the hole position identification section, to be the hole.

2. The exposure device of claim 1, wherein the hole position identification section determines the position of the hole in the exposure surface of the photosensitive material on the basis of measurement data of heights of positions of the exposure surface of the photosensitive material from a distance measurement section, which measures the heights of positions of the exposure surface of the photosensitive material, and
the displacement data generation section generates the displacement data without utilizing the measurement data for the position which is determined to be the position of the hole in the exposure surface of the photosensitive material.

3. The exposure device of claim 2, wherein the displacement data generation section compares the measurement data at a first measurement position according to the distance measurement section with the measurement data at a measurement position near the first measurement position according to the distance measurement section and, if a difference between values of these measurement data exceeds a predetermined value, corrects or disregards the measurement data at the first measurement position according to the distance measurement section.

4. The exposure device of claim 1, wherein the hole position identification section comprises a hole formation position information acquisition section, which acquires data of an occasion of hole formation in the photosensitive material by a hole formation section, and
the disposition data generation section identifies the position of the hole at the photosensitive material on the basis of the data of the occasion of hole formation in the photosensitive material by the hole formation section, and corrects or disregards the measurement data at that position.

5. The exposure device of claim 2, further comprising, in addition to the distance measurement section and the focusing section, a hole co-ordinate measurement section for identifying the position of the hole at the photosensitive material,
wherein, if second measurement data at a second measurement position, which is acquired by the distance measurement section, includes a value equal to or greater than a predetermined value,
the displacement data generation section compares the second measurement position at which the second measurement data is acquired with a hole co-ordinate position obtained by the hole co-ordinate measurement section and, if these two positions coincide, judges that the second measurement position at which the second measurement data is acquired corresponds to the position of the hole at the photosensitive material and, for a predetermined range about the second measurement position, corrects or disregards the second measurement data.

6. The exposure device of claim 2, further comprising, in addition to the distance measurement section and the focusing section, a hole position co-ordinate input section for identification by a user of the position of the hole at the photosensitive material,
wherein, if third measurement data at a third measurement position, which is acquired by the distance measurement section, includes a value equal to or greater than a predetermined value,
the displacement data generation section compares the third measurement position at which the third measurement data is acquired with a hole co-ordinate position inputted by the user beforehand and, if these two positions coincide, judges that the third measurement position at which the third measurement data is acquired corresponds to the position of the hole at the photosensitive material and, for a predetermined range about the third measurement position, corrects or disregards the third measurement data.

7. The exposure device of claim 2, further comprising, in addition to the distance measurement section and the focusing section, a hole co-ordinate measurement section for identifying the position of the hole at the photosensitive material and a hole position co-ordinate input section for identification by a user of the position of the hole at the photosensitive material,
wherein, if fourth measurement data at a fourth measurement position, which is acquired by the distance measurement section, includes a value equal to or greater than a predetermined value,
the displacement data generation section compares the fourth measurement position at which the fourth measurement data is acquired with a hole co-ordinate first position obtained by the hole co-ordinate measurement section and a hole co-ordinate second position inputted by the user beforehand and, if these three positions coincide, judges that the fourth measurement position at which the fourth measurement data is acquired corresponds to the position of the hole at the photosensitive material and, for a predetermined range about the fourth measurement position, corrects or disregards the fourth measurement data.

8. The exposure device of claim 1, wherein, for a predetermined range about a co-ordinate position which is determined to be the hole, the displacement data generation section specifies data which differs from measurement data measured at a measurement position in the range to serve as measurement data peripheral to the co-ordinate position which is determined to be the hole.

9. The exposure device of claim 1, wherein the displacement data generation section subjects measurement data acquired by a distance measurement section to moving average processing and updates the measurement data.

10. The exposure device of claim 1, wherein the focusing section comprises:
a plurality of optical members disposed at a respective emission side of at least one exposure head structuring the exposure section, the optical members being formed with wedge shapes of light-transmissive material and being arranged adjacent to one another, along an optical axis of a light beam emitted from the exposure head, with mutually opposite orientations;
an optical member support section, which supports one optical member of the plurality of optical members to be movable along a face thereof which opposes another optical member of the plurality; and
an optical member traversal section, which causes the one optical member to move along the opposing face relative to the other optical member.

11. The exposure device of claim 10, wherein the exposure head performs imaging by altering modulation states of respective pixels to turn the pixels on and off in accordance with inputted image information.

12. A method for exposing a photosensitive material by emitting a light beam which is modulated in accordance with image data while the photosensitive material is being relatively moved, the method comprising:
determining a position of a hole in an exposure surface of the photosensitive material;
performing focusing control for causing a focusing position of the light beam to coincide with the exposure surface; and
generating displacement data for the focusing control, excluding a position which is determined, on the basis of results of determination of the hole position, to be the hole.

13. The exposure method of claim 12, further comprising:
measuring heights of positions of the exposure surface of the photosensitive material; and
determining the position of the hole in the exposure surface of the photosensitive material on the basis of measurement data of the heights of positions of the exposure surface of the photosensitive material,
wherein the generating of displacement data generates the displacement data without utilizing the measurement data for the position which is determined to be the position of the hole in the exposure surface of the photosensitive material.

14. The exposure method of claim 13, further comprising:
comparing the measurement data at a first measurement position with the measurement data at a measurement position near the first measurement position; and,
if a difference between values of these measurement data exceeds a predetermined value, one of correcting and disregarding the measurement data at the first measurement position.

15. The exposure method of claim 12, further comprising:
performing identification of the hole position by acquiring data of an occasion of hole formation in the photosensitive material;
identifying the position of the hole at the photosensitive material on the basis of the data of the occasion of hole formation in the photosensitive material; and
one of correcting and disregarding the measurement data at that position.

16. The exposure method of claim 13, further comprising, if second measurement data at a second measurement position includes a value equal to or greater than a predetermined value:
comparing the second measurement position at which the second measurement data is acquired with a hole co-ordinate position obtained by measurement of a hole co-ordinate; and,
if these two positions coincide,
judging that the second measurement position at which the second measurement data is acquired corresponds to the position of the hole at the photosensitive material and,
for a predetermined range about the second measurement position, one of correcting and disregarding the second measurement data.

17. The exposure method of claim 13, further comprising, if third measurement data at a third measurement position includes a value equal to or greater than a predetermined value:
comparing the third measurement position at which the third measurement data is acquired with a hole co-ordinate position inputted by a user beforehand; and,
if these two positions coincide,
judging that the third measurement position at which the third measurement data is acquired corresponds to the position of the hole at the photosensitive material and,
for a predetermined range about the third measurement position, one of correcting and disregarding the third measurement data.

18. The exposure method of claim 13, further comprising, if fourth measurement data at a fourth measurement position includes a value equal to or greater than a predetermined value:
comparing the fourth measurement position at which the fourth measurement data is acquired with a hole co-ordinate first position and a hole co-ordinate second position, which is inputted by a user beforehand; and,
if these three positions coincide,
judging that the fourth measurement position at which the fourth measurement data is acquired corresponds to the position of the hole at the photosensitive material and,
for a predetermined range about the fourth measurement position, one of correcting and disregarding the fourth measurement data.

19. An exposure device for exposing a workpiece with one or a plurality of an exposure head, which relatively moves with respect to the workpiece, the exposure device comprising:
a workpiece displacement measurement section, which measures displacements of an exposure surface of the workpiece;
a hole co-ordinate measurement section, which finds a co-ordinate of a hole formed in the workpiece;
a displacement data generation section, which generates displacement data of the exposure surface in accordance with results of measurement at the workpiece displacement measurement section; and
a focusing section, which aligns a focusing point of a light beam emitted from the exposure head with the exposure surface on the basis of the displacement data generated by the displacement data generation section,
wherein, when a displacement amount equal to or greater than a predetermined magnitude is detected by the workpiece displacement measurement section, the displacement data generation section compares a position of detection of this displacement amount with a hole co-ordinate position found by the hole co-ordinate measurement section and, if the two positions coincide, determines that a step corresponding to the displacement amount corresponds to the hole formed in the workpiece and, for a predetermined range about the hole, sets a displacement amount which differs from the measured displacement amount for generating the displacement data.

20. An exposure device for exposing a workpiece with one or a plurality of an exposure head, which relatively moves with respect to the workpiece, the exposure device comprising:
a workpiece displacement measurement section, which measures displacements of an exposure surface of the workpiece;
a displacement data generation section, which generates displacement data of the exposure surface in accordance with results of measurement at the workpiece displacement measurement section; and
a focusing section, which aligns a focusing point of a light beam emitted from the exposure head with the exposure surface on the basis of the displacement data generated by the displacement data generation section,
wherein, when a displacement amount equal to or greater than a predetermined magnitude is detected by the workpiece displacement measurement section, the displacement data generation section compares a position of detection of this displacement amount with a hole co-ordinate position inputted by a user beforehand and, if the two positions coincide, determines that a step corresponding to the displacement amount corresponds to the hole formed in the workpiece and, for a predetermined range about the hole, sets a displacement amount which differs from the measured displacement amount for generating the displacement data.

21. An exposure device for exposing a workpiece with one or a plurality of an exposure head, which relatively moves with respect to the workpiece, the exposure device comprising:
a workpiece displacement measurement section, which measures displacements of an exposure surface of the workpiece;
a hole co-ordinate measurement section, which finds a co-ordinate of a hole formed in the workpiece;
a displacement data generation section, which generates displacement data of the exposure surface in accordance with results of measurement at the workpiece displacement measurement section; and
a focusing section, which aligns a focusing point of a light beam emitted from the exposure head with the exposure surface on the basis of the displacement data generated by the displacement data generation section,
wherein, when a displacement amount equal to or greater than a predetermined magnitude is detected by the workpiece displacement measurement section, the displacement data generation section compares a position of detection of this displacement amount with a hole co-ordinate position found by the hole co-ordinate measurement section and a hole co-ordinate position inputted by a user beforehand, and, if the three positions coincide, determines that a step corresponding to the displacement amount corresponds to the hole formed in the workpiece and, for a predetermined range about the hole, sets a displacement amount which differs from the measured displacement amount for generating the displacement data.

22. A method for exposing a workpiece with one or a plurality of an exposure head, which relatively moves with respect to the workpiece, the method comprising:
a workpiece displacement measurement step for measuring displacements of an exposure surface of the workpiece;
a displacement data generation step for generating displacement data of the exposure surface in accordance with results of measurement in the workpiece displacement measurement step;
a focusing step for aligning a focusing point of a light beam emitted from the exposure head with the exposure surface on the basis of the displacement data generated by the displacement data generation step; and
a hole co-ordinate measurement step for finding a co-ordinate of a hole formed in the workpiece,
wherein, when a displacement amount equal to or greater than a predetermined magnitude is detected in the workpiece displacement measurement step, the displacement data generation step includes comparing a position of detection of this displacement amount with a hole co-ordinate position found by the hole co-ordinate measurement step and, if the two positions coincide, judging that a step corresponding to the displacement amount corresponds to the hole formed in the workpiece and, for a predetermined range about the hole, setting a displacement amount which differs from the measured displacement amount for generating the displacement data.

23. An exposure method for exposing a workpiece with one or a plurality of an exposure head, which relatively moves with respect to the workpiece, the exposure method comprising:
a workpiece displacement measurement step for measuring displacements of an exposure surface of the workpiece;
a displacement data generation step for generating displacement data of the exposure surface in accordance with results of measurement in the workpiece displacement measurement step; and
a focusing step for aligning a focusing point of a light beam emitted from the exposure head with the exposure surface on the basis of the displacement data generated by the displacement data generation step,
wherein, when a displacement amount equal to or greater than a predetermined magnitude is detected in the workpiece displacement measurement step, the displacement data generation step includes comparing a position of detection of this displacement amount with a hole co-ordinate position inputted by a user beforehand and, if the two positions coincide, judging that a step corresponding to the displacement amount corresponds to the hole formed in the workpiece and, for a predetermined range about the hole, setting a displacement amount which differs from the measured displacement amount for generating the displacement data.

24. A method for exposing a workpiece with one or a plurality of an exposure head, which relatively moves with respect to the workpiece, the method comprising:
a workpiece displacement measurement step for measuring displacement of an exposure surface of the workpiece;
a hole co-ordinate measurement step for finding a co-ordinate of a hole formed in the workpiece;
a displacement data generation step for generating displacement data of the exposure surface in accordance with results of measurement in the workpiece displacement measurement step; and
a focusing step for aligning a focusing point of a light beam emitted from the exposure head with the exposure surface on the basis of the displacement data generated by the displacement data generation step,
wherein, when a displacement amount equal to or greater than a predetermined magnitude is detected in the workpiece displacement measurement step, the displacement data generation step includes comparing a position of detection of this displacement amount by the workpiece displacement measurement step with a hole co-ordinate position found in the hole co-ordinate measurement step and a hole co-ordinate position inputted by a user beforehand, and, if the three positions coincide, first judging that a step corresponding to the displacement amount corresponds to the hole formed in the workpiece and, for a predetermined range about the hole, setting a displacement amount which differs from the measured displacement amount for generating the displacement data.

25. An exposure device for exposing a photosensitive material with an exposure section which emits a light beam modulated in accordance with image data while the photosensitive material is relatively moved, the exposure device comprising:
an unevenness portion position identification section, which determines a position of an unevenness portion of an exposure surface of the photosensitive material;
a focusing section, which performs focusing control for causing a focusing position of the light beam from the exposure section to coincide with the exposure surface; and
a displacement data generation section, which generates displacement data for the focusing control by the focusing section, excluding a position which is determined, on the basis of results of determination by the unevenness portion position identification section, to be the unevenness portion.

26. A method for exposing a photosensitive material by emitting a light beam which is modulated in accordance with image data while the photosensitive material is being relatively moved, the method comprising:
determining a position of an unevenness portion of an exposure surface of the photosensitive material;
performing focusing control for causing a focusing position of the light beam to coincide with the exposure surface; and
generating displacement data for the focusing control, excluding a position which is determined, on the basis of results of determination of the unevenness portion position, to be the unevenness portion.
